(19) United States
(12) Patent Application Publication
(10) Pub. No.: US 2007/0114273 A1
(43) Pub. Date: May 24, 2007

(54) Transaction cooperation method in branch office system

(76) Inventors: Toshiyuki Tsutsui, Tokyo (JP); Kazuma Kurata, Tokyo (JP); Akihito Itou, Yokohama (JP); Masataka Itakura, Yokohama (JP); Tetsuhide Ikeda, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/513,381

(22) Filed: Aug. 31, 2006

(30) Foreign Application Priority Data
Nov. 18, 2005 (JP) 2005-333559

(51) Int. Cl. G07F 19/00; G06Q 40/00

(52) U.S. Cl. 235/379; 705/44

(57) ABSTRACT

A cooperating process between respective terminals (apparatuses) in a branch office system for a transaction for a customer who does not have an account or a customer who is supposed to open an account (namely, a customer who does not have a card) is disclosed. In the case where a customer does not have an account, executable transactions are extracted and authority (temporary authority) for the input transaction is issued. The authority is used to operate plural transaction terminals in a cooperating manner so as to enable the transactions. The authority includes issuing of a transaction card. Further, the authority includes using biological information including a vein of a finger or a palm in order to specify an individual.

### BACKGROUND OF THE INVENTION

The present invention relates to a technique for realizing a transaction, requested by a customer, which is conducted by two or more terminal apparatuses in a cooperating manner in a so-called branch office.

As a conventional technique for realizing a transaction that is conducted by two or more terminal apparatuses in a cooperating manner, there is given Japanese Patent Application Laid-Open No. H11-45364. The followings are described in the conventional technique. When transaction information and biometric data are input with a predetermined terminal apparatus and a transaction is started with an ATM, the biometric data of a customer is obtained to be compared with the one input with the predetermined terminal apparatus for identity verification. When the identity verification is done, a transaction based on the transaction information input with the predetermined terminal apparatus is started.

### SUMMARY OF THE INVENTION

However, in the conventional technique, a customer is required to have an account in advance as a premise. This fact can be clarified by such a description in paragraph 0014 that deposit and saving data of a customer is obtained from a host computer. Therefore, a problem arises that a transaction for a customer who does not have an account or a customer who is supposed to open an account (namely, a customer who does not have a card) cannot be dealt with.

Further, in the conventional technique, there is described the fact that a customer can conduct only one transaction. In more detail, consideration is not given to the case that a customer requests plural transactions in one visit. Therefore, after completion of the first transaction, another transaction has to be started from the predetermined terminal apparatus in the conventional technique.

In order to solve the above problem, according to the present invention, in the case where a customer does not have an account, executable transactions are extracted and authority (temporary authority) for the input transaction is issued. The authority includes issuing of a transaction card. Further, the authority includes using biological information including a vein of a finger or a palm in order to specify an individual.

Moreover, according to the present invention, in the case where two or more transactions are requested, “general” transaction information including a total amount necessary for these transactions in an ATM is presented.

In more detail, the present invention includes the following aspect. In a transaction cooperation method in a branch office system in which control relating to a transaction is executed by the branch office system having plural transaction terminals connected to a branch office server for executing a information process relating to the transaction through a network: a first transaction terminal that is included in the plural transaction terminals accepts a transaction request including transaction content from a customer; the first transaction terminal accepts identity verification information for verifying identity, and an input of individual (transaction) identification information to be used for the transaction; the branch office server receives the transaction request and the individual (transaction) identification information from the first transaction terminal; the branch office server specifies a second transaction terminal that accepts procedures for the transaction specified by the transaction request, and notifies the first transaction terminal of the specified second transaction terminal; the first transaction terminal outputs information for specifying the notified second transaction terminal; the second transaction terminal inputs the individual (transaction) identification information in accordance with an operation by the customer; the second transaction terminal transmits the input individual (transaction) identification information to the branch office server; the branch office server specifies the transaction requested by the customer with the use of the transmitted individual (transaction) identification information, and transmits the specified transaction to the second transaction terminal; and the second transaction terminal outputs a display for prompting an operation in order to execute the transaction. It should be noted that the individual (transaction) identification information may be used only for the transaction. However, after the transaction is completed, the individual (transaction) identification information does not become a hindrance to the other customers or the customer himself/herself.

Further, in the above-described processes, the aspect of the present invention includes executing the following processes.

In the case where the first transaction terminal accepts, from the customer, information indicating that the customer does not have an account, the first transaction terminal displays transactions available for the customer, and accepts the transaction request for the transaction selected by the customer among the displayed transactions.

In the case where the first transaction terminal accepts, from the customer, the information indicating that the customer does not have an account, the first transaction terminal specifies transactions available for the customer who does not have an account, and displays the transactions available for the customer.

In the case where the first transaction terminal accepts the information indicating that the customer does not have an account from the customer: the first transaction terminal transmits the information to the branch office server; the branch office server specifies the transactions available for the customer who does not have an account, and transmits the information indicative of the specified transactions to the first transaction terminal, and the first transaction terminal displays the transactions available for the customer on the basis of the received information.

When the first transaction terminal accepts transaction requests for plural transactions from the customer and the branch office server specifies plural transaction terminals as the second transaction terminals, the branch office server notifies the first transaction terminal of the plural specified transaction terminals, and the first transaction terminal outputs information for specifying the plural notified transaction terminals.

The first transaction terminal accepts a first transaction request for a first transaction included in the plural transactions and specifies first identity verification information required for the first transaction to accept an input of the first identity verification information; accepts a second transaction request for a second transaction included in the plural transactions and specifies second identity verification information required for the second transaction to compare the second identity verification information with the first identity verification information; and, as a result of the comparison, specifies identity verification information unique to the second transaction to output a display for prompting the customer to input the identity verification information unique to the second transaction.

The branch office server specifies a payment transaction terminal to which the customer is first lead among the plural specified transaction terminals; calculates a total amount to be paid by the customer for the plural transactions; and notifies the payment transaction terminal of the calculated total amount; and the payment transaction terminal displays the total amount so as to prompt the customer to make a payment.

The payment transaction terminal counts the total amount paid by the customer; displays available transactions with the paid amount among the plural transactions in the case where the counted, paid amount is less than the total amount; accepts a selection of a transaction made by the customer among the displayed transactions; and transmits the selected transaction to the branch office server; and the branch office server controls management information for the plural transactions in accordance with the selection.

The branch office server controls the management information of the selected transaction in accordance with the selection so that the management information indicates execution of the selected transaction, and/or controls the management information of an unselected transaction in accordance with the selection so that the management information indicates inexecution of the unselected transaction.

The payment transaction terminal displays the available transactions among the plural transactions in accordance with priorities.

The priorities are determined in accordance with at least one of each amount of the plural transactions, a due date and a transaction type.

The priorities are determined by the payment transaction terminal or the branch office server.

The branch office server stores the identity verification information received from the first transaction terminal, determines a completion status of the transaction on the basis of a notification from any one of the plural transaction terminals, and deletes the stored identity verification information in the case where the (completion status) is detected. It should be noted that the completion status means completion up to a predetermined stage, which includes the time when an input by a customer is completed, the time when a transaction is completed, the time when information is outputted from the branch office, and the time when a certain period elapses after completion of an input and the like.

In a transaction cooperation method in a branch office system, in the case where plural transaction terminals are specified as the second transaction terminals, the branch office server specifies a final transaction terminal to which the customer is lead last among the plural second transaction terminals, the specified final transaction terminal transmits a transaction execution notification which is information for executing the transaction to the branch office server, and in the case where the transaction execution notification is received, the branch office server deletes the stored identity verification information by determining the reception of the notification as a completion status.

The present invention includes the branch office system, the branch office server, other processing apparatuses, and programs stored in computer-readable media, all of which execute the above-described processes. The programs maybe distributed via networks.

According to the present invention, a transaction executed by a cooperation process can be realized even for a customer who does not have an account. Further, two or more transactions can be realized by the cooperation process.

### BRIEF DESCRIPTION OF THE DRAWINGS

FIG. 1 is a system configuration diagram according to an embodiment of the present invention;

FIG. 2 is a diagram showing a temporary card/finger vein information holding table 2000;

FIG. 3 is a diagram showing a transaction information table 3000;

FIG. 4 is a diagram showing a next transaction-apparatus table 4000;

FIG. 5 is a flowchart explaining reception processes according to the embodiment of the present invention;

FIG. 6 is a flowchart explaining transaction processes according to the embodiment of the present invention;

FIGS. 7A to 7J are diagrams showing guidance screens of a terminal;

FIGS. 8A to 8J are diagrams showing the guidance screens of the terminal; and

FIGS. 9A to 9J are diagrams showing the guidance screens of the terminal.

### DESCRIPTION OF THE PREFERRED EMBODIMENTS

An embodiment of the present invention will be described using the drawings. The embodiment will be described with an example of a branch office system (counter system) of financial facilities, but the present invention is not limited thereto.

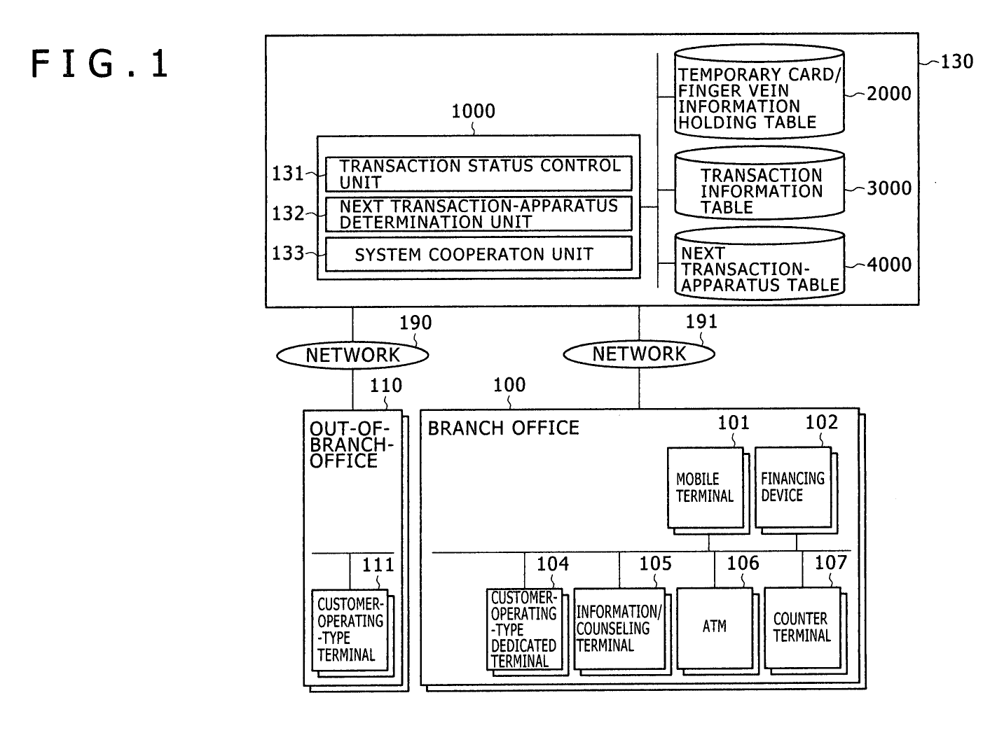

First, a system configuration diagram in the embodiment is shown in FIG. 1. In the system, a branch office system server 130 is connected to respective apparatuses within a branch office 100 through a network 191, and is also connected to respective apparatuses provided in an out-of-branch-office 110 through a network 190. Each computer (apparatus) has a storage apparatus including a memory and a hard disk, and a processing apparatus such as a CPU. The processing apparatus executes information processing in accordance with a program stored in the storage apparatus. The respective apparatuses of the branch office 100 include a mobile terminal (including a mobile phone) 101, a financing device 102, a customer-operating-type dedicated terminal 104, an information/counseling terminal 105, an automated teller machine (ATM) 106, and a counter terminal 107. The apparatuses provided in the out-of-branch-office 110 include a customer-operating-type terminal 111. In addition, the apparatuses provided in the out-of-branch-office 110 may be a personal computer and a mobile phone of a customer. The network 191 is a dedicated line (including so-called Intranet) for the branch office, and the Internet may be used as the network 190.

The branch office system server 130 has a processing unit 1000 including a CPU, and a storage apparatus. The processing unit 1000 executes respective processes in accordance with a program stored in the storage apparatus. The program includes a transaction status control unit 131 for controlling a transaction status, a next transaction-apparatus determination unit 132 for determining an apparatus (terminal) to which a customer is lead, and a system cooperation unit 133 for realizing cooperation between the systems. Further, the storage apparatus stores a temporary card/finger vein information holding table 2000 for storing temporary card/finger vein information, a transaction information table 3000 for storing transaction information of a customer, and a next transaction-apparatus table 4000 for use to determine a next transaction-apparatus (terminal) for a customer.

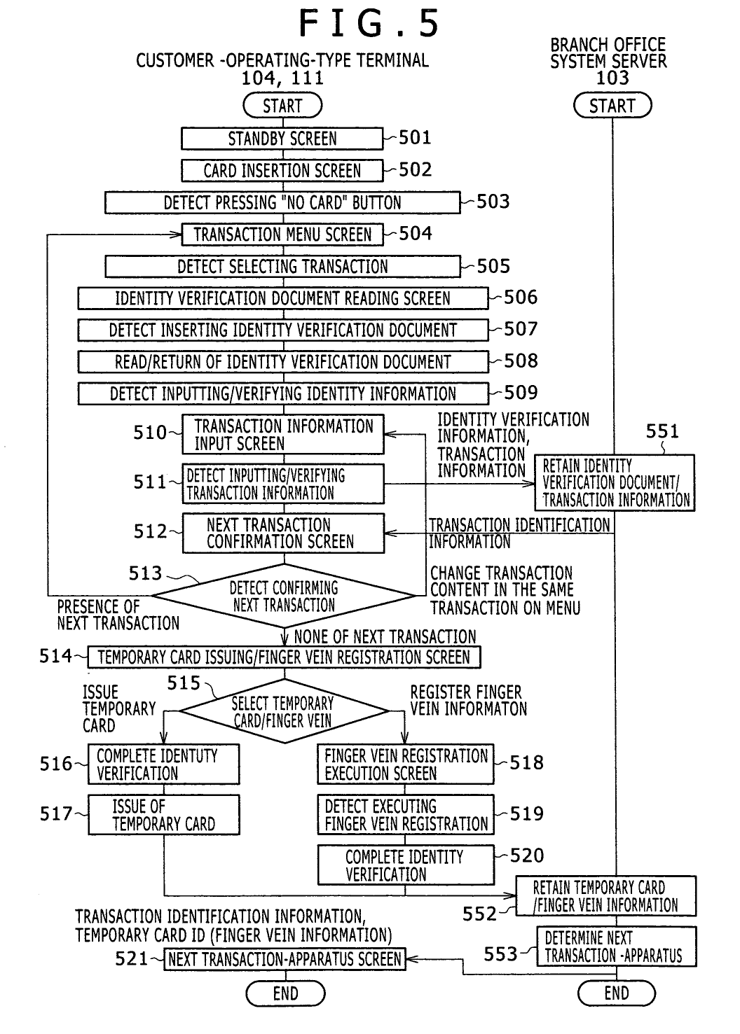

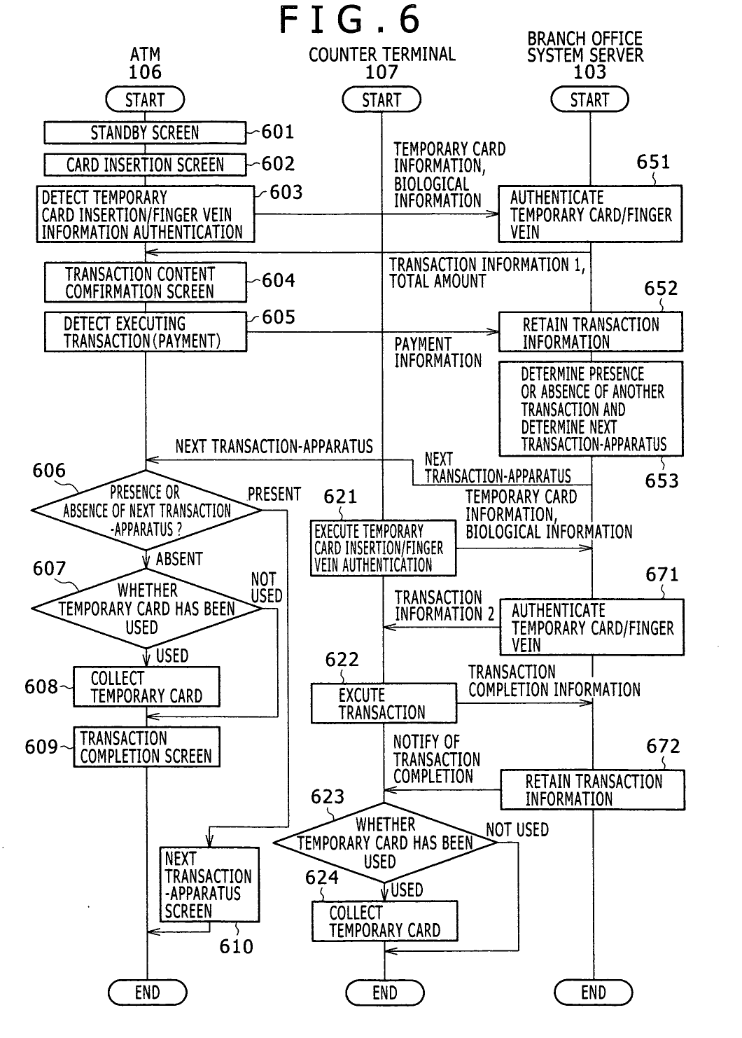

Hereinafter, the processing content of the embodiment will be described using flowcharts in FIGS. 5 and 6. First, a transaction reception process will be described using FIG. 5.

First, a customer operates the customer-operating-type terminal 104 (or 111). The customer-operating-type terminal 104 can be operated by a customer, and is used to execute a reception process and the like when a customer visits a branch office. The customer-operating-type terminal 104 has an input device such as a so-called touch panel, and further has a display screen.

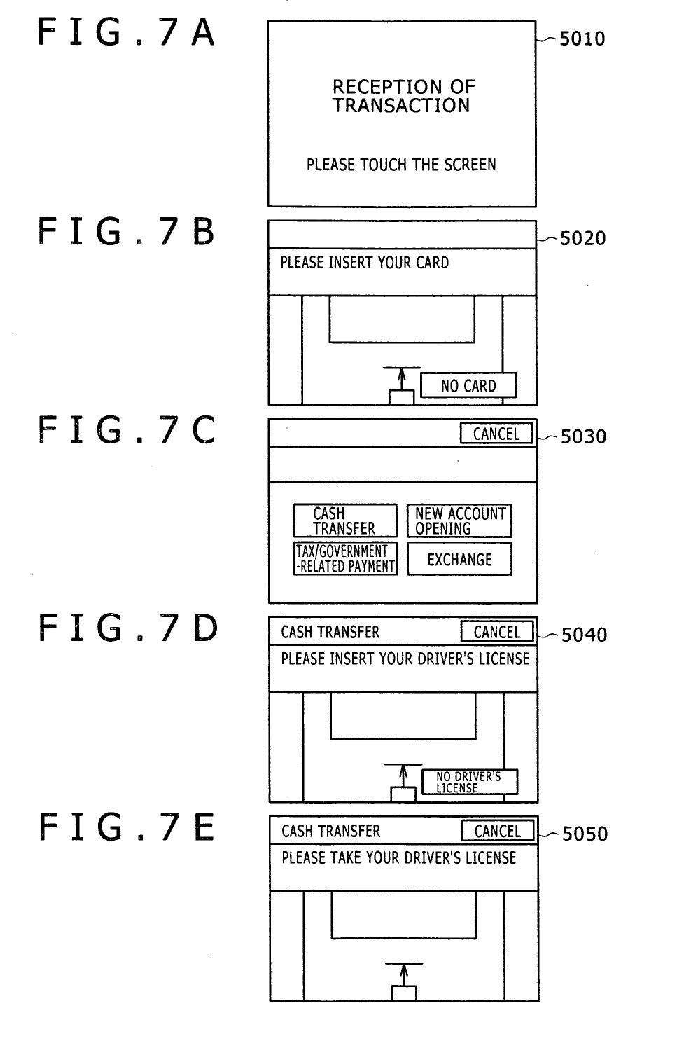

The customer-operating-type terminal 104 displays a standby screen as an initial state (Step 501). For example, as shown in FIG. 7A, a screen for prompting an input by a customer is displayed. Next, when the input (touching the screen) by the customer is detected, the flow proceeds to Step 502. Specifically, as shown in FIG. 7B, a card insertion screen for prompting a card insertion is displayed. Further, as shown in FIG. 7B, a selection button of “no card” is also displayed. Here, when the customer inserts a card (namely, a cash card or the like), a transaction screen is displayed to start a transaction selected by the customer among the displayed transactions. Specifically, a next transaction-apparatus is displayed in accordance with the content written in the IC card and the content of the selected transaction.

When the customer-operating-type terminal 104 detects that the customer presses the “no card” button in Step 503, the flow proceeds to Step 504.

In Step 504, a transaction menu on which the customer selects (or instructs) a transaction to be conducted is displayed as shown in FIG. 7C. Here, the transaction screen may be changed depending on the case of card insertion and the case of no card. Specifically, available transactions are changed between a customer who has a card (or account) and a customer who does not have a card. For example, if the customer has the card, available transactions at the branch office are displayed. On the other hand, if the customer does not have the card, available transactions may be limited to cash transfer, new account opening, tax/government-related payment and exchange. Therefore, each transaction is associated with information indicating whether or not the transaction is available depending on presence or absence of the card, so as to be stored in the customer-operating-type terminal 104, and the customer-operating-type terminal 104 controls a display on the basis of the stored content.

Further, when the customer inserts a wrong card in Step 503, the above-described screen may be displayed in Step 504. Specifically, the customer-operating-type terminal 104 determines whether or not the inserted card is for a bank to which the branch office belongs, on the basis of bank identification information stored in the card, and if the result shows negative, the flow proceeds to Step 504. Without directly proceeding to Step 504, an error message may be displayed or an error message may be displayed before proceeding to Step 504.

In Step 505, the customer-operating-type terminal 104 receives a selection of a transaction (a selection on the transaction menu) made by the customer, and detects the selected content. In the embodiment, an explanation will be given to a case that cash transfer is selected.

In response to the transaction selection (detection) in Step 505, the customer-operating-type terminal 104 displays a screen on which “identity verification document” necessary for the transaction is read in Step 506. Even in the case of cash transfer, information for verifying the identity is needed due to the money laundering problem. In this case, a screen for requesting an insertion of a driver's license is displayed as shown in FIG. 7D.

In response thereto, when the customer inserts the driver's license, the customer-operating-type terminal 104 detects the insertion of the driver's license (Step 507), the driver's license is read and returned (discharged from an insertion slot or a return slot) to the customer (Step 508). At this time, a screen as shown in FIG. 7E may be displayed. It should be noted that the reading of the driver's license includes reading of image data in an optical manner with the use of a scanner or the like. Further, a character recognition process may be executed for the read image data.

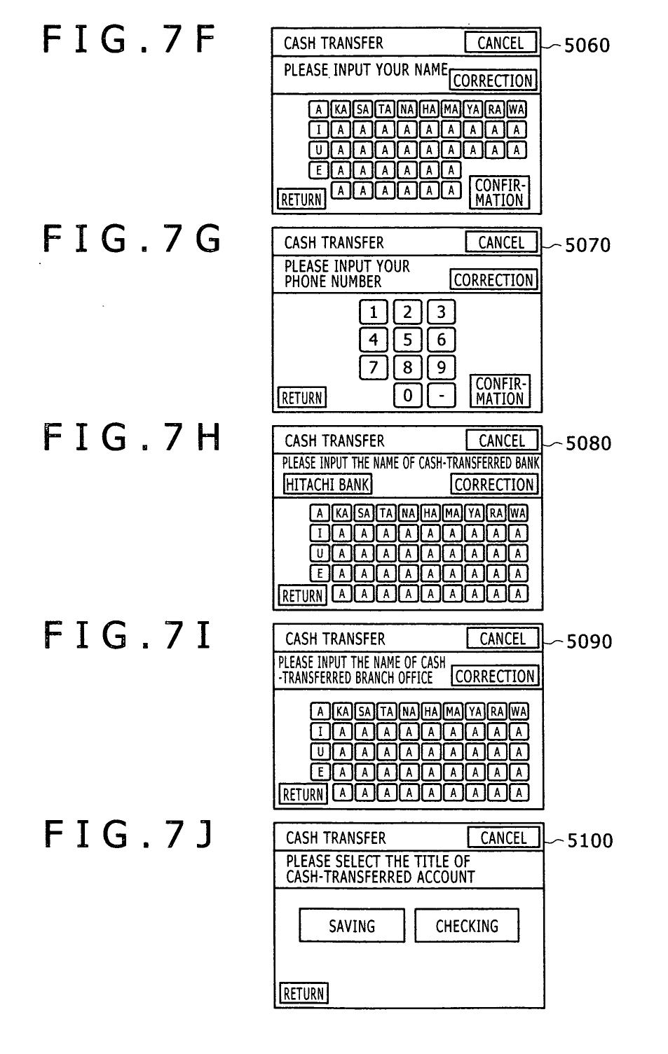

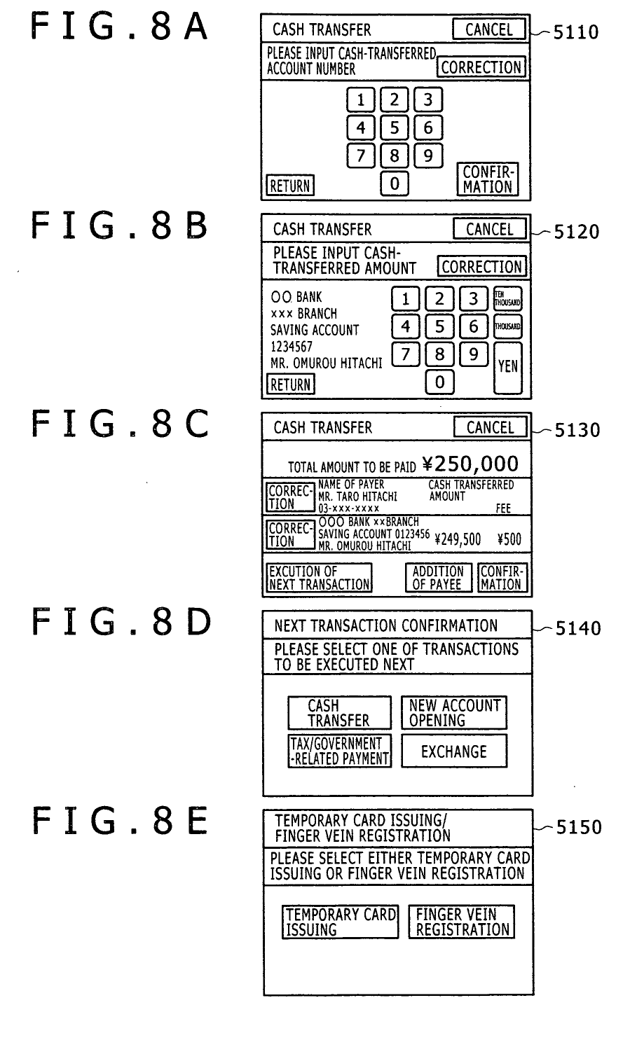

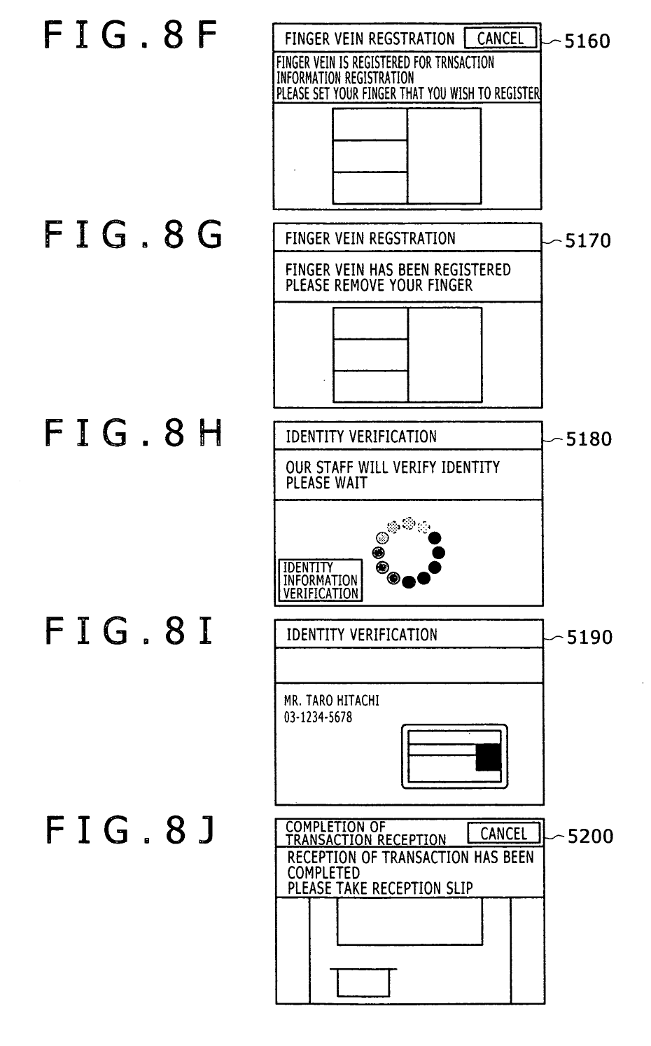

In Step 510, the customer-operating-type terminal 104 displays a transaction information input screen for prompting the customer to input transaction information necessary for the transaction, namely, the cash transfer selected in Steps 504 and 505. First, the customer-operating-type terminal 104 displays screens as shown in FIGS. 7F to 8B. In FIGS. 7F to 8B, the customer is required to input the name of the customer, a phone number of the customer, the name of a cash-transferred financial facility, the name of a cash-transferred branch office, the title of a cash-transferred account, the cash-transferred account number, and a transferred amount, respectively. It should be noted that the transaction information received at this point suffices if it can specify a payee and the amount of cash transfer on the system side, and may be information other than those described above. In addition, the information for specifying the customer, such as the name and a phone number of the customer may be excluded.

In Step 511, the customer-operating-type terminal 104 detects the input (confirmation) of the transaction information, and transmits the transaction information and the identity verification information read in Step 506 to the branch office system server 103. In Step 511, the customer-operating-type terminal 104 compares the information (name) for specifying the customer with the identity verification information (the name written on the driver's license). If the result shows mismatching, an error message may be displayed on the display screen to prompt the customer to input the information again. The customer-operating-type terminal 104 may display the transaction content as shown in FIG. 8C to prompt the customer to press a confirmation button on the screen.

Next, in Step 551, the branch office system server 103 receives the transmitted transaction information and identity verification information, and stores the same in the storage apparatus. The transaction information is stored in the transaction information table 3000. At this time, transaction identification information for identifying the transaction is issued, and is also stored in the transaction information table 3000 while being associated with the transaction. When the information is stored in such a manner, confirmation information is notified to the customer-operating-type terminal 104. This notification contains the transaction identification information for identifying the transaction.

In Step 512, the customer-operating-type terminal 104 displays a next transaction confirmation screen to confirm whether or not the customer conducts the next transaction (which includes a transaction of cash transfer to another payee) which is another transaction. FIG. 8D is the one as an example of the screen.

In Step 513, the customer-operating-type terminal 104 detects the content input by the customer on the next transaction confirmation screen. If the customer-operating-type terminal 104 detects a selection of “addition of payee” on the next transaction confirmation screen shown in FIG. 8C, the flow returns to Step 510 to repeat the above-described processes. If the customer-operating-type terminal 104 detects a selection of “execution of next transaction”, the flow returns to Step 504. The content of the process in this case will be described later. Further, if the customer-operating-type terminal 104 detects a selection of “confirmation”, the flow proceeds to Step 514. The content of the process in this case will also be described later.

An explanation will be given to the case that the flow returns to Step 504 when the selection of “execution of next transaction” is detected. First, in Step 504, the customer-operating-type terminal 104 displays the transaction menu for a customer who does not have a card. This is because the embodiment is described with an example of a customer who does not have a card. Then, in Step 505, the customer-operating-type terminal 104 accepts a selection of a transaction (a selection on the transaction menu) made by the customer. Here, the selected transaction is compared in content with the transaction that was previously selected. If the result shows matching, the flow proceeds to Step 510 to execute the same processes as described above. If the result shows mismatching, the identity verification information that was stored in advance while being associated with each transaction and that is necessary for the selected transaction is compared. Specifically, the identity verification information associated with the transaction that was previously selected is compared with the identity verification information associated with the transaction that is selected at this time. If the result shows matching and the identity verification information for the transaction that is selected at this time is included in the identity verification information for the transaction that was previously selected, the flow proceeds to Step 510. If the result of the comparison shows a lack of identity verification information, the flow proceeds to Step 507 to prompt the customer to input the lacking identity verification information.

Thereafter, Steps 507 to 510 are executed to proceed to Step 511. In Step 511, the identity verification information and the transaction information are transmitted, however, in the case where the identity verification information and the transaction information were previously transmitted as in the case of the embodiment, the transaction identification information that is transmitted in Step 551 is transmitted. The transaction identification information suffices if it can be associated with the transaction information and the like that were previously transmitted. Therefore, the transaction identification information may be the one obtained by converting the previously-transmitted transaction identification information according to a predetermined rule, or may be the same as the previously-transmitted transaction identification information. The explanation of the “execution of next transaction” is now completed.

Next, processes that follow Step 514 will be described. In Step 514, the customer-operating-type terminal 104 displays a screen for prompting the customer to input information for allowing the respective terminals (apparatuses) to cooperate with each other in the transaction. In the embodiment, the screen is displayed such that any one of temporary card issuing and finger vein registration is selected (refer to FIG. 8E). As a scheme other than these, for example, other biological information (a finger print, an iris or the like) may be used, or identification information may be displayed on the screen so as to be memorized by the customer.

In Step 515, the customer-operating-type terminal 104 accepts a selection made by the customer on the display screen in Step 514. If the customer-operating-type terminal 104 detects a selection of “temporary card”, the flow proceeds to Step 516. On the contrary, if the customer-operating-type terminal 104 detects a selection of “finger vein registration”, the flow proceeds to Step 518.

First, an explanation will be given to the case of “temporary card”. In Step 516, the customer-operating-type terminal 104 accepts identity verification information. Specifically, the customer-operating-type terminal 104 accepts a result obtained by a clerk (bank clerk) of the branch office who asks the customer a question or verifies the identity with a visual check. The customer-operating-type terminal 104 may accept an input of the identity verification information by the clerk, or may accept, through the network, an input of the identity verification information by the clerk on an apparatus such as the counter terminal 107. Further, unlike the case of verification by the clerk, the customer may input information about himself/herself, and the identity verification information may be searched for from the branch office system server 103 to be displayed for confirmation by the customer himself/herself. During the verification of the identity, an image as shown in FIG. 8H may be displayed on the screen. When the verification result is received, identity information as shown in FIG. 8I may be displayed.

When accepting the identity verification information (the input of the identity verification information), the customer-operating-type terminal 104 issues a “temporary card” (which is used for cooperation in the transaction). The issue of the temporary card includes discharging of a temporary card which is kept within the customer-operating-type terminal 104 and which stores a temporary card ID that is identification information of the card. The temporary card ID and the transaction identification information notified in Step 551 are transmitted from the customer-operating-type terminal 104 to the branch office system server 103. Specifically, the customer-operating-type terminal 104 reads the temporary card ID from the temporary card and the transaction identification information that is notified and stored in the storage apparatus in Step 551, and transmits them to the branch office system server 103. Alternatively, without storing the temporary card ID on the kept temporary card, the customer-operating-type terminal 104 may produce a temporary card ID on accepting the identity confirmation, and then may write the ID on the temporary card. In this case, the temporary card ID may be used as the above-described transaction identification information, or the produced temporary card ID and the transaction identification information may be written on the temporary card.

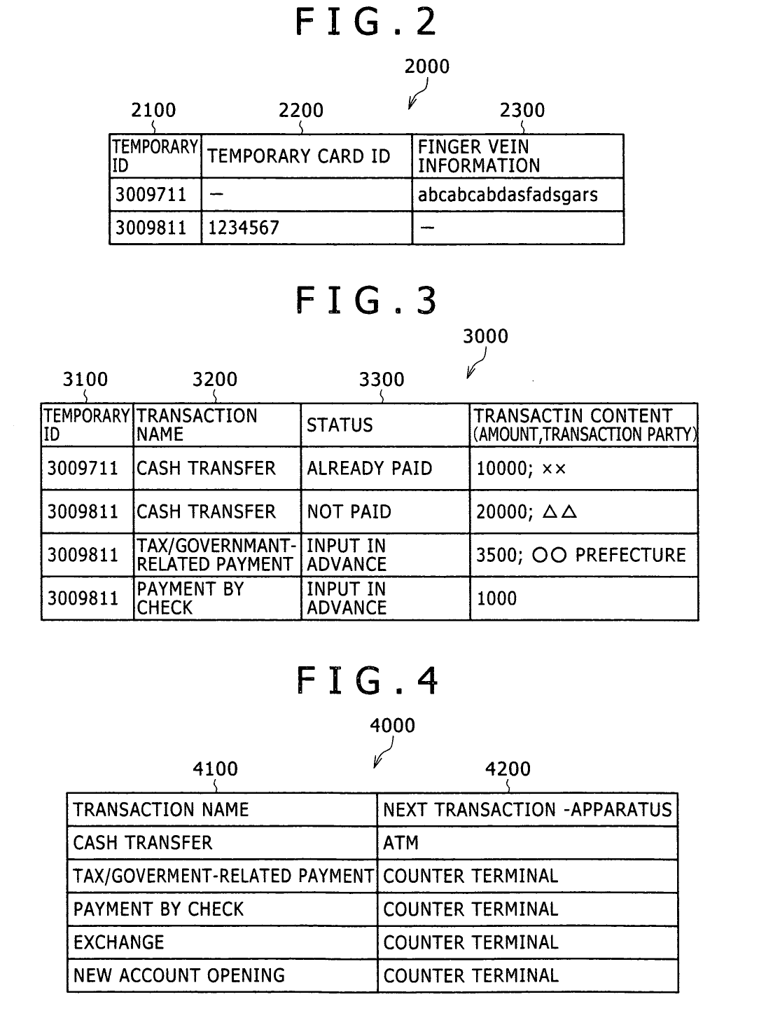

On receiving the transmission, in step 552, the branch office system server 103 stores the transmitted information in the temporary card/finger vein information holding table 2000 shown in FIG. 2. Specifically, the transmitted temporary card ID is stored in 2200 and the transmitted transaction identification information is stored in 2100 as a temporary ID. Although only one temporary ID is stored in FIG. 2, if plural pieces of transaction identification information are present, plural temporary IDs may be stored in one cell (area), or may be stored by dividing them into plural records.

In the embodiment, the temporary card ID is used in a different way from the temporary ID (transaction identification information), however, these may be the same (or they have a predetermined relation). In this case, the temporary card ID may not be stored in advance in the temporary card that is kept in the customer-operating-type terminal 104. In Step 517, the customer-operating-type terminal 104 may write the transaction identification information on the temporary card, and may use the same. In this case, the area in which the temporary card ID is stored may not be provided in the temporary card/finger vein information holding table 2000. Further, the temporary card may be held by a clerk, and when identity verification is completed, the clerk may hand it to the customer. The explanation of the case that the temporary card is selected in Step 515 is now completed.

Next, an explanation will be given to the case that the finger vein registration is selected in Step 515. The customer-operating-type terminal 104 displays a finger vein registration execution screen in Step 518. For example, the screen is displayed such that the customer is prompted to set a finger at a reader as shown in FIG. 8F. The reader is not particularly shown in the figure, however, the reader may be integrated with the customer-operating-type terminal 104, or may be connected to the customer-operating-type terminal 104 via a cable or the like.

When the customer sets a finger at the reader in response to Step 518, the customer-operating-type terminal 104 reads finger vein information of the customer through the reader in Step 519. When the reading is done, a screen as shown in FIG. 8G is displayed, and the flow proceeds to Step 520. In Step 520, the same process as that in Step 516 is executed. When the identity verification is completed, the finger vein information and the transaction identification information are transmitted from the customer-operating-type terminal 104 to the branch office system server 103, and then are stored in the temporary card/finger vein information holding table 2000 as similar to Step 517. As previously described in Step 517, the finger vein information is used in the same way as the temporary card ID. However, if the finger vein information is used (processed) in the same way as the temporary card ID, the following processes are executed. First, the branch office system server 103 that received the transaction identification information and the finger vein information replaces the transaction identification information stored in Step 551 with the finger vein information. Thereafter, the finger vein information is stored in the temporary card/finger vein information holding table 2000. It should be noted that only the temporary card information or only the finger vein information may be stored in the temporary card/finger vein information holding table 2000.

Next, in Step 553, the branch office system server 103 determines a next transaction-apparatus for the customer on the basis of the transaction identified with the temporary card ID (finger vein information or temporary ID). The transaction terminals used in the respective transactions are stored as a table in the branch office system server 103 while being associated with the respective transactions (for example, cash transfer—ATM, tax/government-related payment—counter terminal). By running the table with the information stored in Step 551, a terminal (apparatus) to be used in the transaction requested by the customer is specified. Further, the order of priorities of next transaction-apparatuses for each transaction or each terminal is stored as a table. The table is used for a specified terminal or an input transaction so that the order of next transaction-apparatuses is determined. For example, the next transaction-apparatuses may be given priorities such as ATM-1, counter terminal-2, and information/counseling terminal-3, and the priorities may be stored. Alternatively, the priorities may be stored as a matrix that shows which terminal (transaction) has a high priority (or a low priority). Further, the priorities may be given depending on the type of each terminal and then stored. Alternatively, the priorities may be given to each terminal and then stored.

In response thereto, the branch office system server 103 specifies a next transaction-apparatus while giving priorities, and transmits the resultant to the customer-operating-type terminal 104. Further, the information of the next transaction-apparatus is stored in the branch office system server 103.

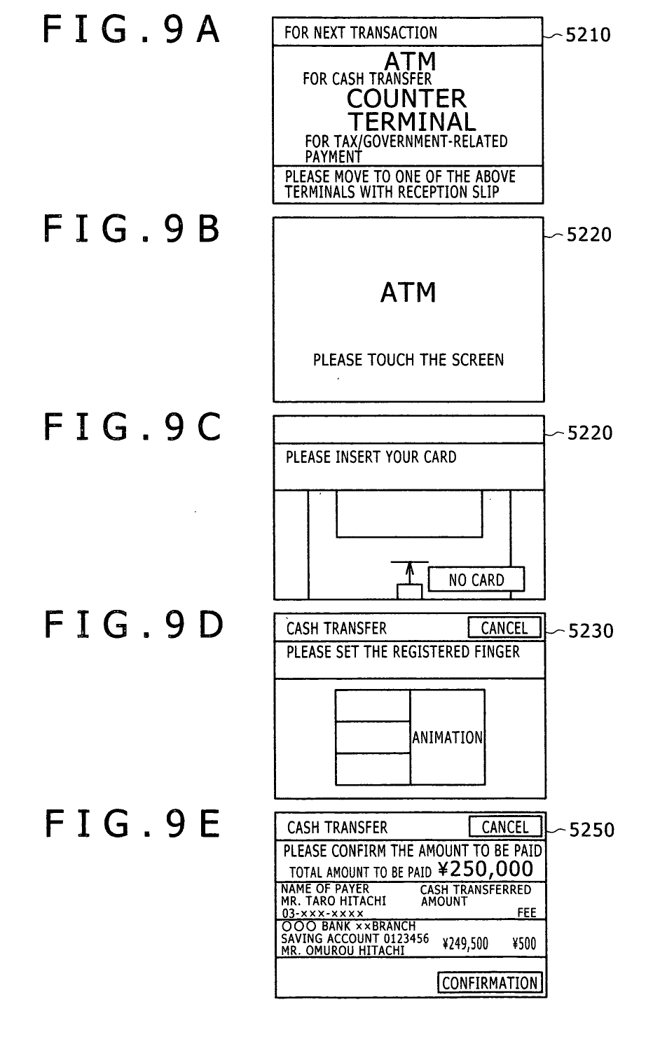

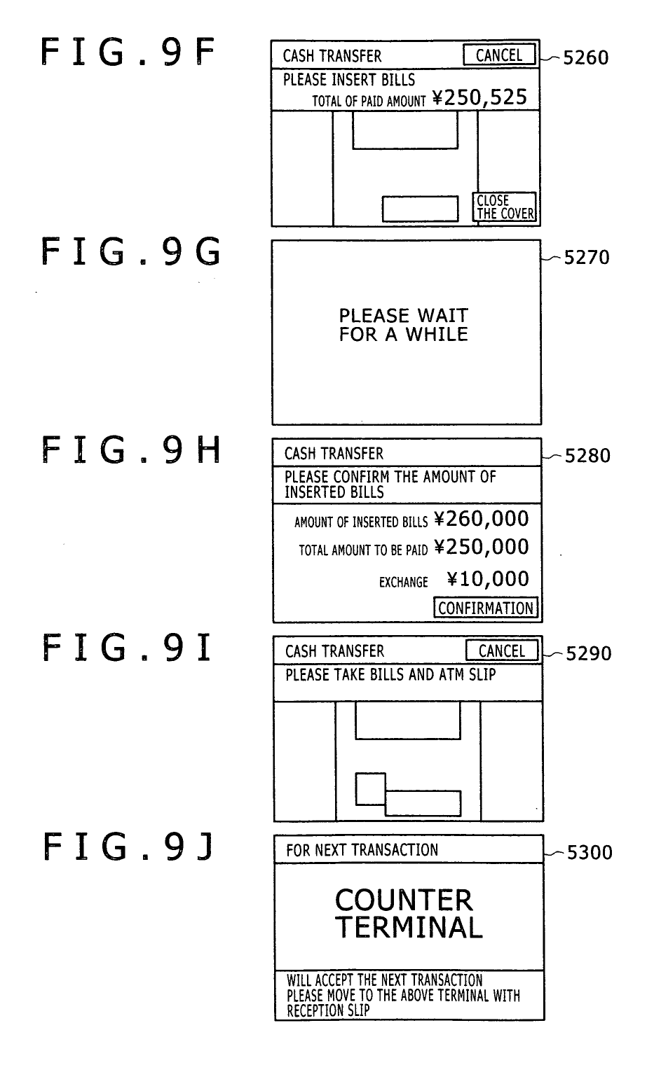

In Step 521, the customer-operating-type terminal 104 displays a fact that the reception of the transaction is completed, as shown in FIG. 8J. At this time, a reception slip (sheet) may be output. The temporary ID may be printed on the reception slip in a two-dimensional bar code format or a numeral format. Alternatively, the content of the transaction (including an amount) or the next transaction-apparatus may be printed thereon. Further, the customer-operating-type terminal 104 displays information indicative of the next transaction-apparatus as shown in FIG. 9A. The explanation of the reception processes is now completed. In the above-described reception processes, the customer-operating-type terminal 104 may delete the identity verification information stored in the customer-operating-type terminal 104 under the condition that the customer-operating-type terminal 104 has received the notification in Step 551 from the branch office system server 103. Alternatively, the condition may be that the customer-operating-type terminal 104 has received information relating to the next transaction-apparatus in Step 553. Further, in these cases, the fact of the deletion may be displayed or written on the display screen or the reception slip.

In the case where the customer-operating-type terminal 111, namely, the customer-operating-type terminal provided in the out-of-branch-office 110 is used, information (map, the name of a branch office and the like) for specifying a branch office may be output as a guidance screen. The information for specifying a branch office may be displayed continuously with or in conjunction with the above-described information for specifying a terminal. In these cases, the customer-operating-type terminal 111 may store in advance a branch office to which the customer is lead, or may store plural pieces of branch office information while associating with respective pieces of information indicating available transactions at the respective branch offices. Further, as the information indicating available transactions, the information for specifying a terminal (apparatus) may be used.

Next, processes relating to transactions after the reception will be described using FIG. 6. First, the customer moves to the ATM 106 in accordance with the display of FIG. 9A.

The ATM 106 displays a standby screen as shown in FIG. 9B or 29 (Step 601). For example, in the case where the terminal also has a function other than an ATM function, the standby screen shown in FIG. 9B is displayed when the ATM function is ready to be executed. When the ATM 106 detects that the customer touches the standby screen, FIG. 9B is transited to a card insertion screen as shown in FIG. 9C. As described above, FIG. 9C may be used as a standby screen.

Next, when the ATM 106 detects an input on the card insertion screen, the ATM 106 obtains identification information in the following manner in accordance with the input content to transmit the same to the branch office system server 103 (Step 603). Here, the identification information is the one that can identify at least one of a transaction, a temporary card, and a customer. (1) In the case where the ATM 106 detects an insertion of a temporary card, the ATM 106 reads temporary card information stored on the temporary card to transmit the same to the branch office system server 103. The temporary card information includes a temporary card ID. Further, in the case where transaction identification information is stored in the temporary card, the information may be included in the temporary card information. (2) When the ATM 106 detects that the customer presses “no card” button on the card insertion screen, the ATM 106 displays a screen as shown in FIG. 9D to prompt the customer to set “finger” (biological part) at a reader. In this display, a guidance of setting a finger may be displayed using animations or characters. When a finger is set at the reader in response to the display, the ATM 106 reads finger vein information of the biological information through the reader. Then, the ATM 106 transmits the read finger vein information to the branch office system server 103.

Next, in Step 651, the branch office system server 103 executes an authentication process for the received identification information. The temporary card/finger vein information holding table 2000 is searched for the information corresponding to the received authentication information. If the information is located, the transaction information table 3000 is searched for the transaction information corresponding to the information, and the located transaction information is transmitted to the ATM 106. Hereinafter, the processing content will be described separately in the case of using a temporary card and in the case of using finger vein information.

(1) Temporary card ID: It is assumed that a temporary card ID=1234567 was received as the transaction information. When a search is performed on the temporary card/finger vein information holding table 2000 with the temporary card ID as a key, the temporary card ID=1234567 locates 3009811 of the temporary ID. Next, when a search is performed on the transaction information table 3000 with the located temporary ID as a key, the following two pieces of transaction information can be located.

Transaction information 1: name of transaction=cash transfer, status=not paid, transaction content=20000 Yen, To xx Transaction information 2: name of transaction=tax/government-related payment, status=input in advance, transaction content=3500 Yen, 000 Prefecture

The located transaction information 1 and 2 are stored in a predetermined table. At this time, the temporary ID may be stored while being associated therewith. When storing these pieces of information, the storing is performed after confirming whether or not the transaction information 1 and 2 are already stored. This confirmation process may be performed using the temporary ID. In stead of storing in the table, information (e.g., flag) indicating that a search is already done may be stored in the transaction information table 3000.

In the case where the transaction identification information to be transmitted includes the temporary ID (transaction identification information), a search may be performed on the transaction information table 3000 with the temporary card ID as a key.

Then, the branch office system server 103 extracts the transaction information 1 from the located transaction information. The extraction process is performed in the following manner. In Step 651, the branch office system server 103 receives “ATM” as terminal type identification information that identifies the terminal type of the ATM 106. The branch office system server 103 searches the next transaction-apparatus table 4000 (the next transaction-apparatus section) for the transaction name “cash transfer” with the terminal type identification information “ATM” as a key. Since transaction information including the transaction name “cash transfer” is the transaction information 1, the transaction is specified with the transaction information 1.

Further, the branch office system server 103 adds up the amounts of the transaction information 1 and 2. Consequently, the transaction information 1 and the added amount are transmitted to the ATM 106. In the case of showing a completion of the transaction such as already paid by confirming the status prior to the transmission, information indicating that the transaction is already completed is transmitted. At this time, information for specifying a terminal to which the customer is lead next may be transmitted using the next transaction-apparatus information stored in Step 553. If plural transactions corresponding to the ATM are located, the respective results are transmitted.

Although the total amount of the transaction information 1 and 2 is calculated, this process may be omitted. In this case, if the transaction of the transaction information 2 is executed, the customer is prompted to pay again.

(2) Finger vein information: Processes in the case of using finger vein information are basically the same as those in the case of using the temporary card ID in (1). The case of using finger vein information differs in information to be used from the case of using the temporary card ID, and the other processes are the same.

The transaction content of the transaction information is for specifying the content of a transaction, and includes at least information for specifying a recipient such as an amount and a payee. The information for specifying a recipient includes an account number, the name of a bank, and the like.

Next, in Step 604, the ATM 106 displays the received transaction information (including the total amount) on a transaction content confirmation screen. The transaction content confirmation screen contains a transaction name, a transaction amount, and a transaction party as shown in FIG. 9E. The transmitted transaction information may not be the transaction information itself as described above, but may be converted (including partial extraction). In the case where plural transactions are conducted in the ATM, the transaction information may be displayed in a predetermined order, or information relating to plural pieces of transaction information may be displayed to prompt the customer to select a transaction. When the ATM 106 detects that the customer presses the “confirmation” button on the transaction content confirmation screen, the flow proceeds to Step 605.

In Step 605, the ATM 106 displays a screen for prompting the customer to conduct cash transfer (payment for cash transfer) as shown in FIG. 9F. Then, when the payment is made, the cash is counted. If there is no problem with the amount, payment information indicating that the payment is already made is transmitted to the branch office system server 103. The payment information may include the temporary ID (temporary card ID or finger vein information) for the transaction.

In Step 605, the ATM 106 may display screens as shown in FIGS. 9G to 35. The screen shown in FIG. 9g is displayed during the process, and a result of the cash counting is displayed on the screen as shown in FIG. 9F. When the ATM detects that the customer presses the “confirmation” button, the above-described transmission is performed, and then, the screen shown in FIG. 9I is displayed. If an ATM receipt and a change are to be discharged, both are discharged.

In Step 605, if the ATM 106 detects a fact that the paid cash is less than the total amount, the following processes are executed.

(1) Determining a status of the paid amount among the following statuses. (a) The paid amount is less than each of the transaction information 1 and 2. (b) The paid amount is enough for one of the transaction information 1 and 2, but not enough for the other, (b)-1 The paid amount is enough for the transaction information 1, but not enough for the total amount of the transaction information 1 and 2. (b)-2 The paid amount is enough for the transaction information 2, but not enough for the total amount of the transaction information 1 and 2. (b)-3 The paid amount is enough for each of the transaction information 1 and 2, but not enough for the total amount of the transaction information 1 and 2.

(2) If it is determined as (a), an error message is displayed to prompt the customer to pay the lacking amount. If the paid amount is still less than the total amount, the cash that was previously paid is returned.

(3) If it is determined as one of (b)-1 and (b)-2, the fact is displayed. The display content includes the fact that the paid amount is not enough, the name of a transaction for which the paid amount is not enough (“cash transfer” (transaction information 1) or “tax/government-related payment” (transaction information 2)), the lacking amount, and a button with which the customer selects to pay only for an available transaction with the paid cash. When the ATM detects that the customer presses the button, the process for the available transaction is executed in the same way as described above. However, for the transaction for which the paid amount is not enough, cancel information indicative of the cancel of the transaction is transmitted to the branch office system server 103. Like the case of (2), if no payment is made, the transaction is cancelled to return the paid cash.

(4) If it is determined as (b)-3, the fact that the paid amount is not enough for the total amount of the transaction information 1 and 2 is displayed, and buttons for prompting a repayment or a selection of one of the transaction information 1 and 2 are displayed. Instead of this, a button for allowing the user to approve an execution of a transaction having a predetermined high priority may be displayed. Thereafter, the same process as that of (3) is executed.

In Step 652, on receiving the payment information, the branch office system server 103 rewrites the status of the transaction information table 3000. Specifically, the status of the temporary ID 3009811 is changed from “not paid” to “already paid”. Further, the transaction information 1 is deleted from the table in which the located transaction information (transaction information 1 and 2) is stored. Instead of deletion, information indicating that the payment is already made may be written therein. Alternatively, in the case where a flag is stored in the transaction information table 3000 instead of the table, the flag is deleted.

On receiving the cancel information, the branch office system server 103 deletes the corresponding transaction information from the table in which the located transaction information is stored, or writes a flag indicative of cancel (or termination) is written therein. Alternatively, the flag stored in the transaction information table 3000 may be deleted.

In Step 653, the branch office system server 103 determines the presence or absence of another next transaction-apparatus. This determination is made by using the transaction information located in Step 651. That is, remaining transaction information is extracted from the table in which the located transaction information is stored. The remaining transaction information is information that remains without being deleted, or information whose flag is not processed. In the case of using the transaction information table 3000, the information whose flag is stored is extracted. As a result of the extraction, if the transaction information is extracted, it is determined that another next transaction-apparatus is present. The branch office system server 103 specifies another next transaction-apparatus by executing the same process as that described in Step 651. The specifying of the next transaction-apparatus may be determined by using the next transaction-apparatus stored in Step 553.

An explanation will be given to the case that the counter terminal is specified (with the transaction information 2) in the embodiment.

The branch office system server 103 transmits to the ATM 106 information indicating that the next transaction-apparatus is “counter terminal”. If none of the next transaction-apparatus is present, information indicating that none of the next transaction-apparatus is present may be transmitted, or any information may not be especially transmitted. The information to be transmitted may be transmitted with confirmation information indicating that the process is already executed by the branch office system server 103.

In Step 606, the ATM 106 determines the presence or absence of a next transaction-apparatus on the basis of the information received from the branch office system server 103. The ATM determines that a next transaction-apparatus is present if the information contains information indicative of a next transaction-apparatus, and the flow proceeds to Step 610 to display information indicating that the next transaction-apparatus is “counter terminal” on the basis of the received information (FIG. 9J). If the temporary card has been inserted therein, the temporary card is discharged so that the customer can receive it.

If it is determined that none of the next transaction-apparatus is present, the flow proceeds to Step 607. In Step 607, the ATM 106 determines whether the temporary card has been used in the transaction. If the temporary card has been used, the temporary card is collected (Step 608), and the flow proceeds to Step 609 to terminate the transaction. On the contrary, if it is determined that the temporary card has not been used, the flow proceeds to Step 609 from Step 607 to terminate the transaction.

Next, in the case where another next transaction-apparatus (transaction) is present, an example of the tax/government-related payment using the counter terminal 107 will be described. The counter terminal 107 can read finger vein information or temporary card information, and is operated by a clerk of the branch office. The customer moves to the counter terminal 107 on the basis of the display of the ATM 106.

First, the counter terminal 107 executes a temporary card/finger vein information authentication detecting process in Step 621. Specifically, the same process as that executed by the ATM 106 in Step 603 is executed. In Step 671, the branch office system server 103 executes the same process as that executed in Step 651. However, in the case where the located result shows that the corresponding terminal (apparatus) is one “counter terminal” or the number of pieces of transaction information is one, the total amount may not be calculated. In this case, a case that the total amount is not calculated is explained. Therefore, the branch office system server 103 transmits the transaction information 2 to the counter terminal 107.

The counter terminal 107 executes a process for the transaction in accordance with an operation by the clerk on the basis of the transaction information 2 in Step 622. When the transaction is completed after checking of the slip or the like is done and the clerk inputs a completion instruction, the transaction completion information is transmitted to the branch office system server 103.

The branch office system server 103 executes the same processes as those in Step 652 and Step 653. Since this example is based on the case that the located result shows that the corresponding terminal (apparatus) is one “counter terminal” or the number of pieces of transaction information is one, information indicative of completion of the transaction (procedures by the customer) is produced to be notified to the counter terminal 107.

In response thereto, the counter terminal 107 determines whether or not the temporary card has been used in Step 623. This step may be performed in such a manner that the presence or absence of the temporary card is determining by the clerk, and then the counter terminal 107 receives the result. This determination is made in the same way as that in Step 607. If it is determined that the temporary card has been used, the flow proceeds to Step 624 to collect the temporary card, and the process is terminated. On the contrary, if it is determined that the temporary card has not been used, the process is terminated without performing another process. The collection of the temporary card may be performed by the clerk through other workers.

Finally, the branch office system server 103 may delete the identity verification information stored in Step 551 under the condition of reception of the above-described transaction completion information or transmission of the transaction completion notification. In this case, the transaction completion notification may include information indicative of the deletion, and the fact of the deletion may be displayed on the counter terminal 107. Further, the counter terminal 107 may display the fact of the deletion under the condition of the reception of the transaction completion notification even if the transaction completion notification does not include the information indicative of the deletion.

The explanation of the embodiment is now completed. The embodiment has been described with an example of a branch office of financial facilities. However, the embodiment is not limited to the above-described example, and can be applied to another example (an agent of financial facilities).

1. A transaction cooperation method in a branch office system in which control relating to a transaction is executed by the branch office system having a plurality of transaction terminals connected to a branch office server for executing an information process relating to the transaction through a network, the method comprising the steps of:
accepting a transaction request including transaction content from a customer by a first transaction terminal among the plurality of transaction terminals;
accepting, after accepting identity verification information for verifying identity, an input of individual transaction identification information to be used for the transaction by the first transaction terminal;
receiving, by the branch office server, the transaction request and the individual transaction identification information from the first transaction terminal;
notifying, after specifying a second transaction terminal that accepts procedures for a transaction specified by the transaction request, the first transaction terminal of the specified second transaction terminal by the branch office server;
outputting, by the first transaction terminal, information for specifying the notified second transaction terminal;
inputting, by the second transaction terminal, the individual transaction identification information in accordance with an operation by the customer;
transmitting, by the second transaction terminal, the input individual transaction identification information to the branch office server,
transmitting, after specifying the transaction requested by the customer with the use of the transmitted individual transaction identification information, the specified transaction to the second transaction terminal by the branch office server; and
outputting, by the second transaction terminal, a display for prompting an operation in order to execute the transaction.

2. The transaction cooperation method in a branch office system according to claim 1, further comprising the step of displaying transactions available for the customer in the case where the first transaction terminal accepts, from the customer, information indicating that the customer does not have an account,
wherein the step of accepting a transaction request includes accepting the transaction request for the transaction selected by the customer among the displayed transactions.

3. The transaction cooperation method in a branch office system according to claim 2, further comprising the step of specifying, by the first transaction terminal, transactions available for the customer who does not have an account in the case where the first transaction terminal accepts, from the customer, the information indicating that the customer does not have an account,
wherein the step of displaying transactions available for the customer includes displaying transactions specified in the step of specifying transactions.

4. The transaction cooperation method in a branch office system according to claim 2, further comprising, in the case where the first transaction terminal accepts from the customer the information indicating that the customer does not have an account, the steps of:
transmitting the information to the branch office server by the first transaction terminal; and
transmitting, after specifying the transactions available for the customer who does not have an account, the information indicative of the specified transactions to the first transaction terminal by the branch office server,
wherein the step of displaying transactions available for the customer includes displaying the transactions available for the customer by the first transaction terminal on the basis of the received information.

5. The transaction cooperation method in a branch office system according to claim 1, further comprising the step of notifying by the first transaction terminal of a plurality of transaction terminals specified as the second transaction terminals when the first transaction terminal accepts transaction requests for a plurality of transactions from the customer in the step of accepting a transaction request by the branch office server,
wherein the step of outputting information for specifying the second transaction terminal includes outputting information for specifying the plurality of notified transaction terminals.

6. The transaction cooperation method in a branch office system according to claim 5,
wherein the step of accepting a transaction request includes sub-steps of:
accepting, from the customer, an input of a first transaction request for a first transaction included in the plurality of transactions and first identity verification information required for the first transaction, and
accepting, from the customer, an input of a second transaction request for a second transaction included in the plurality of transactions and second identity verification information required for the second transaction, and
the step of outputting a display for prompting an operation includes the sub-steps of:
comparing the second identity verification information with the first identity verification information, and
outputting, after specifying identity verification information unique to the second transaction as a result of the comparison, a display for prompting the customer to input the identity verification information unique to the second transaction.

7. The transaction cooperation method in a branch office system according to claim 6, further comprising the steps of:
specifying, by the branch office server, a payment transaction terminal to which the customer is first lead among the plurality of specified transaction terminals;
calculating, by the branch office server, a total amount to be paid by the customer for the plurality of transactions;
notifying, by the branch office server, the payment transaction terminal of the calculated total amount; and
displaying the total amount by the payment transaction terminal so as to prompt the customer to make a payment.

8. The transaction cooperation method in a branch office system according to claim 7, further comprising the steps of:
counting, by the payment transaction terminal, the total amount paid by the customer;
displaying, by the payment transaction terminal, an available transaction with the paid amount among the plurality of transactions in the case where the counted, paid amount is less than the total amount;
transmitting, after accepting a selection of a transaction made by the customer among the displayed transactions, the selected transaction to the branch office server by the payment transaction terminal; and
controlling, by the branch office server, management information for the plurality of transactions in accordance with the selection.

9. The transaction cooperation method in a branch office system according to claim 8,
wherein the branch office server controls the management information of the selected transaction in accordance with the selection so that the management information indicates execution of the selected transaction.

10. The transaction cooperation method in a branch office system according to claim 8,
wherein the step of displaying available transactions includes displaying available transactions among the plurality of transactions in accordance with priorities.

11. The transaction cooperation method in a branch office system according to claim 10,
wherein the step of displaying available transactions includes displaying available transactions with priorities in accordance with at least one of each amount of the plurality of transactions, a due date and a transaction type.

12. The transaction cooperation method in a branch office system according to claim 11, further comprising the step of determining the priorities by the payment transaction terminal or the branch office server.

13. The transaction cooperation method in a branch office system according to claim 1, further comprising the steps of:
storing, by the branch office server, the identity verification information received from the first transaction terminal;
determining, by the branch office server, a completion status of the transaction on the basis of a notification from any one of the plurality of transaction terminals; and
deleting, by the branch office server, the stored identity verification information in the case where the completion status is detected.

14. The transaction cooperation method in a branch office system according to claim 13, further comprising, in the case where a plurality of transaction terminals are specified as the second transaction terminals, the steps of:
specifying, by the branch office server, a final transaction terminal to which the customer is lead last among the plurality of second transaction terminals;
transmitting, by the specified final transaction terminal, a transaction execution notification, which is information for executing the transaction, to the branch office server; and
deleting, in the case where the transaction execution notification is received, the stored identity verification information by the branch office server by determining the reception of the notification as the completion status.

15. A transaction cooperation system in which control relating to a transaction is executed by the branch office system having a plurality of transaction terminals connected to a branch office server for executing an information process relating to the transaction through a network, the method comprising:
a accepting means for a transaction request including transaction content from a customer by a first transaction terminal among the plurality of transaction terminals;
a accepting means after accepting identity verification information for verifying identity, an input of individual transaction identification information to be used for the transaction by the first transaction terminal;
a receiving means by the branch office server for the transaction request and the individual transaction identification information from the first transaction terminal;
a notifying means after specifying a second transaction terminal that accepts procedures for a transaction specified by the transaction request, the first transaction terminal of the specified second transaction terminal by the branch office server;
an outputting means by the first transaction terminal for outputting information for specifying the notified second transaction terminal;
an inputting means by the second transaction terminal for inputting for the individual transaction identification information in accordance with an operation by the customer;
a transmitting means by the second transaction terminal for transmitting for the input individual transaction identification information to the branch office server,
a transmitting means after specifying the transaction requested by the customer with the use of the transmitted individual transaction identification information, the specified transaction to the second transaction terminal by the branch office server; and
an outputting means by the second transaction terminal for outputting a display for prompting an operation in order to execute the transaction.

16. The transaction cooperation system according to claim 15, further comprising displaying means for displaying transactions available for the customer in the case where the first transaction terminal accepts, from the customer, information indicating that the customer does not have an account,
wherein said accepting means includes accepting the transaction request for the transaction selected by the customer among the displayed transactions.

17. The transaction cooperation system according to claim 16, further comprising a specifying means for specifying by the first transaction terminal transactions available for the customer who does not have an account in the case where the first transaction terminal accepts, from the customer, the information indicating that the customer does not have an account,
wherein said displaying means displays transactions available for the customer includes displaying transactions specified in the step of specifying transactions.

18. The transaction cooperation system according to claim 16, further comprising, in the case where the first transaction terminal accepts from the customer the information indicating that the customer does not have an account, the steps of:
a transmitting means for transmitting the information to the branch office server by the first transaction terminal; and
a transmitting means for transmitting after specifying the transactions available for the customer who does not have an account, the information indicative of the specified transactions to the first transaction terminal by the branch office server,
wherein the displaying means displays transactions available for the customer includes displaying the transactions available for the customer by the first transaction terminal on the basis of the received information.
